(19) United States
(12) Patent Application Publication
(10) Pub. No.: US 2010/0053706 A1
(43) Pub. Date: Mar. 4, 2010

(54) DETECTION OF OPEN SCANNER LID

(75) Inventors: David Wayne Jasinski, Rochester, NY (US); Kirk Douglas Farnung, Rochester, NY (US)

Correspondence Address: David A. Novais;Patent Legal Staff, Eastman Kodak Company, 343 State Street, Rochester, NY, 14650-2201, US

(73) Assignee: Eastman Kodak Company

(21) Appl. No.: 12/200,142

(22) Filed: Aug. 28, 2008

(51) Int. Cl. H04N 1/04

(52) U.S. Cl. 358/498

(57) ABSTRACT

A scanning apparatus for scanning an image that includes a transparent plate and a target region having a predetermined optical reflectance. Also included is a movable sensor array, having a home position that is in optical communication with the target region when a lid of the scanning apparatus is closed. A light source illuminates the target region, and a controller analyzes a signal sent from the movable sensor array and subsequently initiating at least one function for the scanning apparatus.

### FIELD OF THE INVENTION

The present invention relates to the detection of the open or closed status of a lid on a scanning apparatus. The scanning apparatus can be either a stand-alone device or a part of a copier, or a multifunction printer

### BACKGROUND OF THE INVENTION

Optical scanners operate by imaging an object (e.g., a document) with a light source and sensing a resultant light signal with an optical sensor array. Each optical sensor or photoreceptor in the array generates a data signal representative of the intensity of light impinged thereon for a corresponding portion of the imaged object. The data signals from the array sensors are then processed (typically digitized) and stored in a temporary memory such as a semiconductor memory or on a hard disk of a computer; for example, for subsequent manipulation and printing or display, such as on a computer monitor. The image of the scanned object is projected onto the optical photo sensor array incrementally by use of a moving scan line. The moving scan line is produced either by moving the document with respect to a scanner optical assembly, or by moving the scanner optical assembly relative to the document. Either or both of these methods may be embodied in a flat bed scanner, multi-function printer, or any scanner having manual and automatic feed capabilities.

Various types of photo sensor devices may be used in optical scanners. For example, a commonly used photo sensor device is the charge coupled device (CCD). A CCD builds up an electrical charge in response to exposure to light. The size of the electrical charge build up is dependent on the intensity and the duration of the light exposure. In optical scanners, CCD cells are aligned in linear array. The length of the linear array is typically somewhat less than the length or width of the document scanning region. Each photoreceptor of the CCD has a portion of a scan line image impinged thereon as the scan line sweeps across the scanned object. The charge built up in each of the pixels is measured and discharged at regular “sampling intervals.” In most modern optical scanners, the sampling intervals of the CCD arrays are fixed.

An image of a scan line portion of a document is projected onto the scanner's linear sensor array by scanner optics. In CCD scanners, the scanner optics include an imaging lens which typically reduces considerably the size of the projected image from its original size. The scanner optics provide a good depth of field in a CCD scanner. However, because the photoreceptors are so small in the CCD device, a fairly strong light source such as a fluorescent lamp is needed to illuminate the scan line image region of the document in order to provide sufficient signal strength at each photoreceptor site.

A second type of scanner is the contact image sensor (CIS) scanner. A CIS scanner includes a contact image sensor having a length that is substantially equal to the width of the scanning region. The photoreceptors in a CIS are substantially the same size as the pixel resolution of the scanner. Because the photoreceptors in the CIS are so much larger than they are in a CCD, a lower power light source (such as one or more LED's) is sufficient to provide enough illumination in the scan line image region. The CIS has a short depth of field and is typically mounted beneath the transparent plate (scanner glass) upon which the document is placed. One or more rollers in the CIS carriage are biased against the bottom of the scanner glass so that the CIS is always at substantially the same distance from the top of the scanner glass.

Photoreceptors in a CCD or CIS scanner linear photo sensor array are aligned in a “cross” direction, i.e., a direction parallel to the longitudinal axis of the scan line image which is projected thereon. The direction perpendicular to the “cross” direction will be referred to herein as the “scan” direction (e.g., paper or sensor linear array movement direction for scanning of the image).

At any instant when an object is being scanned, each photoreceptor in the sensor array has a corresponding area on the object which is being imaged thereon. This corresponding area on the scanned object is referred to herein as a pixel. An area on a scanned object corresponding in area to the entire area of the linear sensor array is referred to herein as a scan line. For descriptive purposes, a scanned object is considered to have a series of fixed adjacently positioned scan lines. Further, scanners are typically operated at a scan line sweep rate such that one scan line width is traversed during each sampling interval.

In addition, when working with cut sheet print media, a copying, scanning or multifunction printing apparatus may provide automatic document feed, as well as manual document placement capabilities. An automatic document feeder (ADF) mechanism, such as shown in FIG. 2 of U.S. Pat. No. 6,646,768, is capable of automatically loading and unloading single sheets sequentially to a functional station where the apparatus performs an operation, e.g., sequentially scanning the fed document sheets for copying, taxing, displaying on a computer monitor, or the like. Following the operation, the ADF then off-loads a sheet and feeds the immediately following sheet of the document to the functional station. A sequential flow of sheets by the ADF and positioning without the necessity of manual handling reduces the time required to accomplish the complete functional operation.

Each document fed into the ADF is conveyed to an automatic scanning region where the document is scanned by an image sensor and then the document is conveyed to a point outside the ADF, such as a document output tray. During ADF operation, the image sensor remains fixed at the automatic scanning region “reading” or scanning the image as the document is conveyed past the scanning point by the ADF. During manual scanning, the document lays flat on and covers a portion of the flat plate while the image scanner is moved under the plate the length (or width) of the document to read or scan the document. In many flatbed scanners, the scanning point or portion of the flat plate used to scan a document provided by the ADF is separate and distinct from the portion of the flat plate utilized to scan a document manually positioned on the plate.

Scanners also typically include a lid that covers the scanner glass. In manual document placement operation, the lid is lifted so that the user can place the document on the scanner glass and align it properly. The lid is then closed prior to scanning. For scanners that have an ADF, the bottom of the ADF can function as the lid that covers the scanner glass.

Many scanners, multifunction printers, or copiers also include a control panel. The control panel allows the user to control various aspects of the scanning, copying, printing or other functions. The control panel can include a button such as a start button to initiate a scanning or copying operation.

In order to save energy and improve long-term reliability, a scanner, copier or multifunction printer can have an active mode and a sleep mode. In the active mode, power is continuously applied and the apparatus is immediately ready to begin scanning, copying or printing. In the sleep mode, power is not continuously applied to some portions of the apparatus, and it may take the apparatus a few seconds or more to be ready to begin scanning, copying or printing. If a user were to push the start button during or soon after the apparatus is in the sleep mode, the apparatus may seem unresponsive at first.

It is known in the prior art to detect the opening of the scanner lid and use that as a signal for the apparatus to exit the sleep mode and enter the active mode. For units with automatic document feeders, it can also be important to know whether the lid is open so that the ADF operation can be disabled if the lid is open. U.S. Pat. No. 6,316,767 discloses using a light sensor which can detect ambient light if the scanner lid is open, but which would not receive a significant amount of light (in the sleep mode when the scanner light source is off) if the lid is closed. Detecting of the lid opening can be used as a trigger to turn the scanner lamp on, which can be important for cold cathode fluorescent lamps, for example, because warm-up time can be significant. A shortfall in this invention is that in low ambient lighting conditions, the detection of the lid opening may not be reliable.

Thus improved detection of lid opening is needed for more reliable operation, so that productivity is improved and the user experience is enhanced through rapid exiting from the energy-saving sleep mode.

### SUMMARY OF THE INVENTION

The aforementioned need is met by providing a scanning apparatus for scanning an image that includes a transparent plate and a target region having a predetermined optical reflectance. Also included is a movable sensor array, having a home position that is in optical communication with the target region when a lid of the scanning apparatus is closed. A light source illuminates the target region, and a controller analyzes a signal sent from the movable sensor array and subsequently initiating at least one function for the scanning apparatus.

Another aspect of the invention provides a method for detecting whether a lid of a scanning apparatus is open. The method includes positioning a movable sensor array proximate to a target region; illuminating the target region with a light source; and receiving in the movable sensor array a predetermined optical signal corresponding to the target region, if the lid is closed. A lid-open signal is sent to a controller of the scanning apparatus, if the predetermined optical signal corresponding to the target region is not received in the movable sensor array when the light source is on. Alternatively, a lid-closed signal is sent to the controller of the scanning apparatus if the predetermined optical signal corresponding to the target region is received in the movable sensor array when the light source is on.

### BRIEF DESCRIPTION OF THE DRAWINGS

FIG. 1 is a perspective view of a scanning apparatus of a multifunction printer including an exemplary embodiment of the invention;

FIG. 2A shows a view of the underside of the scanner lid including a type of target region, as seen through the scanner glass for the present invention;

FIG. 2B represents the signal along the sensor array corresponding to the target region shown in FIG. 2A;

FIG. 3 is a perspective view of a scanning apparatus of a multifunction printer including another exemplary embodiment of the invention;

FIG. 4A shows a view of the reflective backing plate including another type of target region, as seen from the top of the reflective backing plate;

FIG. 4B represents the signal along the sensor array corresponding to the target region shown in FIG. 4A;

FIG. 5 schematically shows the controller and its relationship with other portions of the scanning apparatus for the present invention; and

FIG. 6 is a perspective view of a scanning apparatus of a multifunction printer having an automatic document feeder and including yet another exemplary embodiment of the invention.

### DETAILED DESCRIPTION OF THE INVENTION

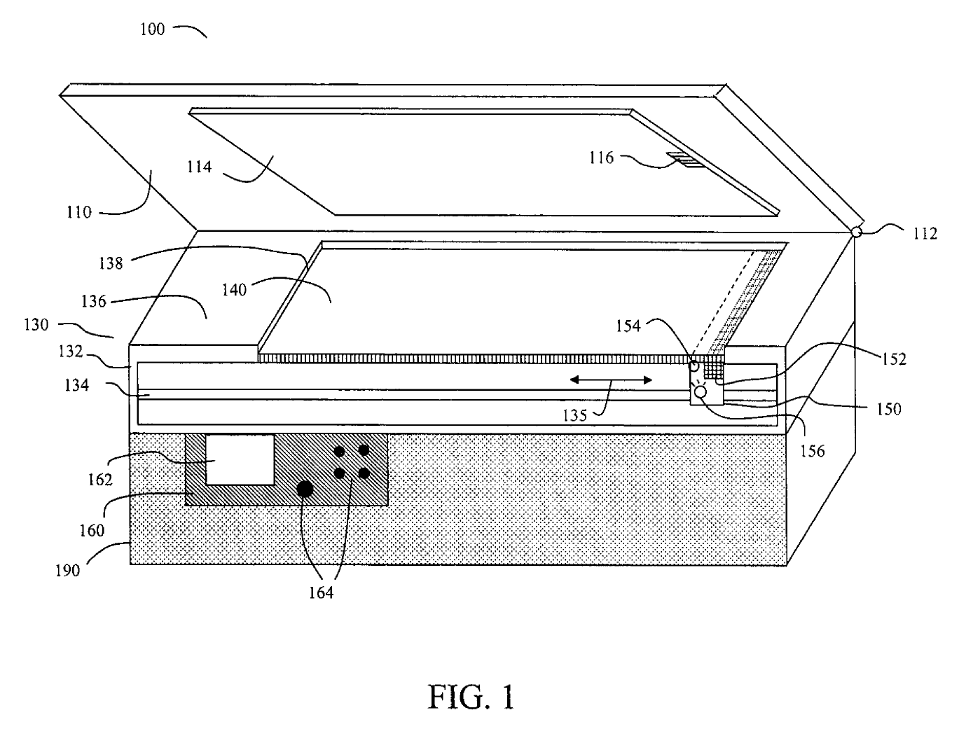

FIG. 1 shows a perspective view of a multifunction printer 100 including a scanning apparatus 130 and a printing apparatus 190. In this view, the front portion of scanning apparatus 130 is cut away in order to show internal features of the scanning apparatus more clearly. Multifunction printer 100 can do printing, scanning of documents, or copying of documents (e.g., printing plus scanning). The printing apparatus 190 portion of the multifunction printer 100 is not central to the invention, and other embodiments of the invention include a separate scanning apparatus, which would be similar to multifunction printer 100 without the printing apparatus 190.

Control panel 160 for the apparatus is shown in FIG. 1 as being mounted on the front of printing apparatus 190, but this was done partly for illustrative purposes so as not to obscure features of the scanning apparatus 130. In other embodiments and especially for a separate scanning apparatus (not shown) where there is no printing apparatus 190, control panel 160, would be located elsewhere. Control panel 160 can include display 162 and a variety of control buttons 164, which can include a start button.

Scanning apparatus 130 includes scanning apparatus body 132 and scanner lid 110, which is joined to scanning apparatus body 132 by hinge 112. The surface of scanning apparatus body 132 that is covered by scanner lid 110 when scanner lid 110 is closed includes a frame 136. Scanner glass 140 (a transparent plate) is inset within the frame 136. In the exemplary embodiment shown, the surface of the scanner glass 140 is lower than the surface of frame 136 so that there is an offset 138.

Below scanner glass 140 is a movable sensor array module 150. In the embodiment shown in FIG. 1, sensor array module 150 includes a sensor array such as a contact image sensor 152 extending the width of the scanner glass 140, a roller 154 that is biased into contact with the underside of the scanner glass 140, and a light source 156 that illuminates a scan line of a document (not shown) that is placed on top of scanner glass 140. A light guide and other optics (not shown) can also be included in sensor array module 150. Sensor array module 150 is moved back and forth along scanning guide 134 in direction 135 across the length of scanner glass 140 in order to scan the document, scan line by scan line. Scanning guide 134 can be a round rail, a rack and pinion or other guiding member that can use the power of a motor (not shown) to provide a linear motion along the scanning direction 135. In FIG. 1, sensor array module 150 is parked in its home position near one end of the scanner glass 140. The home position is where sensor array module 150 returns between scanning operations and also is where sensor array module 150 is parked when the scanning apparatus is in its sleep mode.

In the embodiment shown in FIG. 1, scanner lid 110 Includes a reflective backing plate 114. The thickness of reflective backing plate 114 is accommodated in offset 138 between frame 136 and the top surface of scanner glass 140 when scanner lid 110 is closed. Reflective backing plate 114 can be resiliently mounted on scanner lid 110, so that reflective backing plate 114 is effective in pressing documents of various thicknesses against scanner glass 140. Typically reflective backing plate 114 is white in the document scanning region. Since many documents are printed on white paper, a white reflective backing plate 114, results in an overall white background, even for documents of sizes that are smaller than the scanning region. For other types of objects to be scanned, such as photos, the white reflective backing plate 114 produces a clean background that provides good contrast for the photos.

A novel aspect of the embodiment shown in FIG. 1 is target region 116 positioned such that, if scanner lid 110 is closed, and movable sensor array 152 (as part of movable sensor array module 150) is in its home position, movable sensor array 152 is in optical communication with the target region 116. When light source 156 is turned on, it illuminates target region 116 so that reflections from the target region 116 result in a recognizable signal produced by sensor array 152. However, if scanner lid 110 is open, sensor array 152 is not in optical communication with target region 116, so that even if light source 156 is turned on, the recognizable signal from target region 116 is not produced.

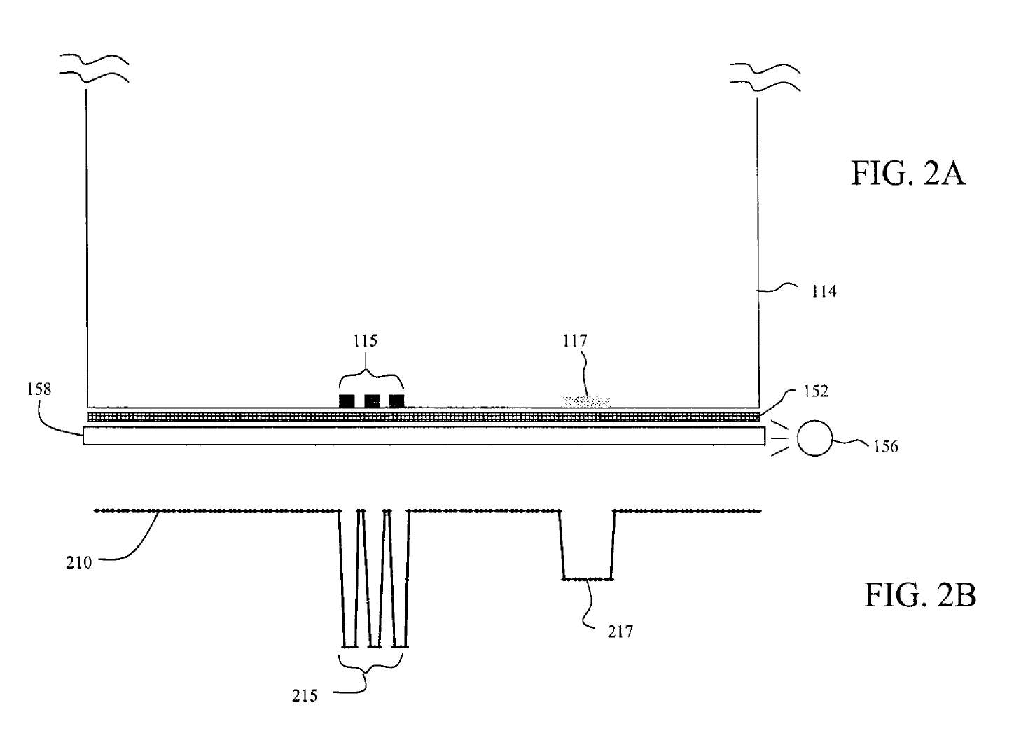

Target region 116 can be confined to a small region near the home position of sensor array 152, or it can extend along the full length of sensor array 152. FIG. 2A shows a view looking up through the scanner glass at reflective backing plate 114 (rotated from the orientation shown in FIG. 1), where two different target regions 115 and 117 are shown along the edge of reflective backing plate 114 that is near the home position of the movable sensor array 152. Also shown in FIG. 2A is light guide 158, which guides the light from light source 156 along the length of sensor array 152 to provide uniform illumination of the scan line region. In the embodiment shown in FIG. 2A, target region 115 includes three black blocks, alternating with white spaces, while target region 117 consists of an elongated gray region. The signal strength at each photoreceptor site of sensor array 152 increases with the amount of light received. FIG. 2B illustrates a signal 210 corresponding to the pattern, including target regions 115 and 117, shown in FIG. 2A when the scanner lid 110 is closed and light source 156 is turned on. Light from light source 156 reflects off the white regions of backing plate 114 that are along the scan line corresponding to the home position of the sensor array 152 and is received in the corresponding photoreceptor sites to produce a large signal. Photoreceptor sites near the black blocks of target region 115 receive a low amount of light because the light is absorbed by the black blocks, so that a low signal is produced by those sites. By having a plurality of black blocks alternating with white regions in target region 115, a distinctive recognizable signal pattern 215 is produced in a known photoreceptor site region of sensor array 152. Similarly, the gray target region 117 absorbs part of the light from light source 156, but also reflects part of the light, so there is a dip 217 in the signal level for a group of photoreceptor sites that corresponds to the location of target region 117. Other embodiments can include target regions 116 that have one or more regions of various optical densities that are different from that of the reflective backing plate 114. Still other embodiments can have target regions 116 of different color in particular target regions. In general these target regions 116 are described herein as having a predetermined optical reflectance. In some embodiments of the invention, the target region 116 includes a first region of optical reflectance (such as the white portion of target region 115) and a second region of optical reflectance (such as the black blocks in target region 115). In addition, the photoreceptor sites are also referred to herein as sensors, so that if the lid is closed, a first sensor of the movable sensor array 152 detects a black block in pattern 115 and produces a first signal level, and a second sensor of the movable sensor array 152 detects a white region and produces a second signal level, so that together the first sensor and the second sensor produce a predetermined signal when the lid is closed. Notably, the target region has one or more features that are preferably optically distinguishable to provide a recognizable signal. If the scanner lid 110 is open, then light from light source 156 is transmitted through scanner glass 140 and only a small portion is reflected off the glass to return to sensor array 152. With the scanner lid 110 open, the signal produced by sensor array 152 is more variable, depending upon ambient light levels. However, the recognizable signal pattern 210 will not be produced, so it is known that the scanner lid 110 is open. Also if light source 156 is turned off but scanner lid 110 is closed, the signal from sensor array 152 will be low along the full length of the array. However, it is not necessary to keep light source 156 turned on all of the time, especially for light sources such as LED's that have a fast turn-on time. Such a light source 156 can be pulsed with a pulsing period that is fairly short compared to timescales that human beings perceive as slow. For example, the light source 156 can be pulsed on and off in a period of less than one second, i.e., at a frequency that is higher than once per second. In an embodiment of the invention, the light source 156 is pulsed on and off twice per second, with an on-time significantly less than the off-time, in order to save energy.

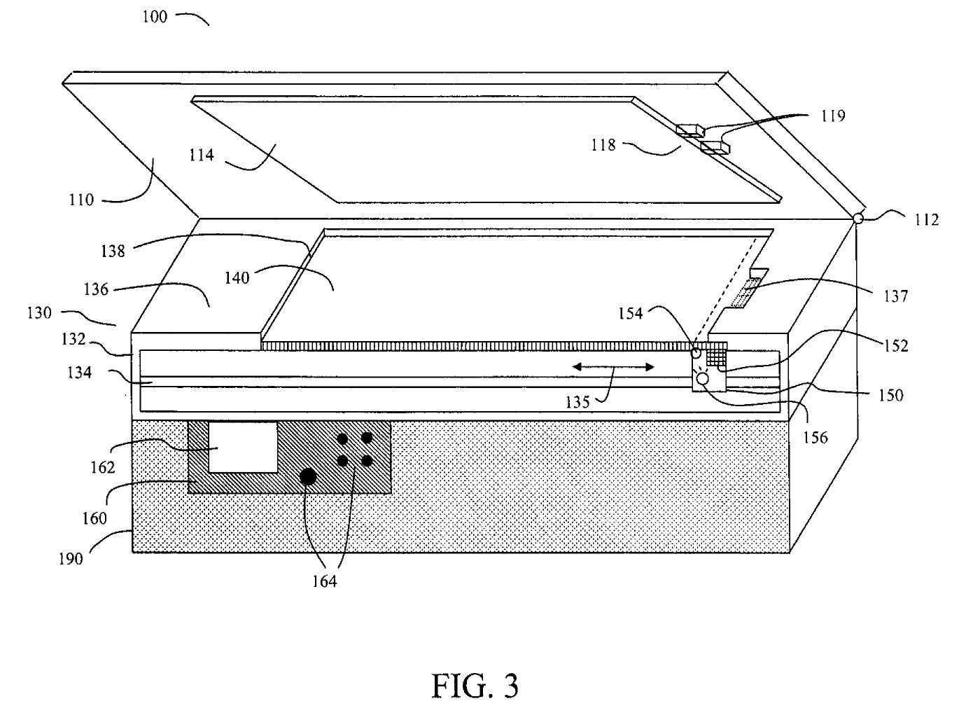

FIG. 3 shows a perspective view of an embodiment in which target region 118 is formed by two projections 119 that extend from the side of the reflective backing plate 114. In this embodiment, frame 136 extends partially over the home position of moving sensor array 152, but there is a notch or recessed region 137 to accommodate projections 119 when the scanner lid 110 is closed.

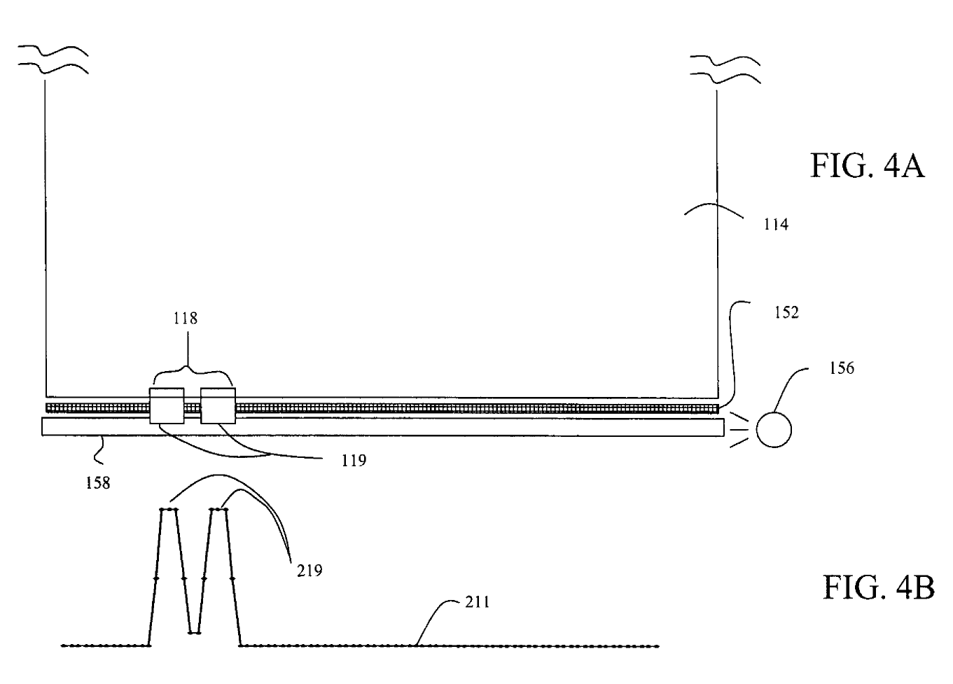

FIG. 4A shows a view from the top side of reflective backing plate 114 corresponding to the embodiment of FIG. 3 (rotated from the orientation shown in FIG. 3), but as if frame 136 is transparent in order to show the position of sensor array 152, light source 156 and light guide 158 more clearly. Actually, in this embodiment, however, frame 136 is black and absorbs light from light source 156, so that sensor array signal 211 is low in regions where the sensor array 152 is covered by frame 136. If the lid is closed, the two white projections 119 in target region 118 of white reflective backing plate 114 produce two corresponding high level signal peaks 219 in the photoreceptor sites (or sensors) near them, because light from light source 156 is reflected off projections 119 and into the corresponding photoreceptor sites. In the region between the two projections 119, light is transmitted through the scanner glass, but is mainly absorbed or scattered by the under side of scanner lid 110. The signal between peaks 219 may not be as low level as the portion of the signal 211 corresponding to the frame 136 covering the sensor array 152, but it is still low enough that two recognizable and distinct peaks 219 are produced corresponding to target region 118. In other embodiments, one projection or more than two projections can also extend from the side of reflective backing plate 114. In all such embodiments, the configuration of projections will correspond to a predetermined optical reflectance.

Optionally, there is no separate reflective backing plate 114, but a target region 116 is formed on the scanner lid 110, itself In any case, the target region 116 has a predetermined optical reflectance with which the movable sensor array 152 is in optical communication when it is located in its home position.

Since the sensor array is generally below the scanner glass 140 and the scanner lid 10, including target region 16, is above the scanner glass 140, it will generally be true that a transparent plate 140 will be positioned between the movable sensor array 152 and the target region 116.

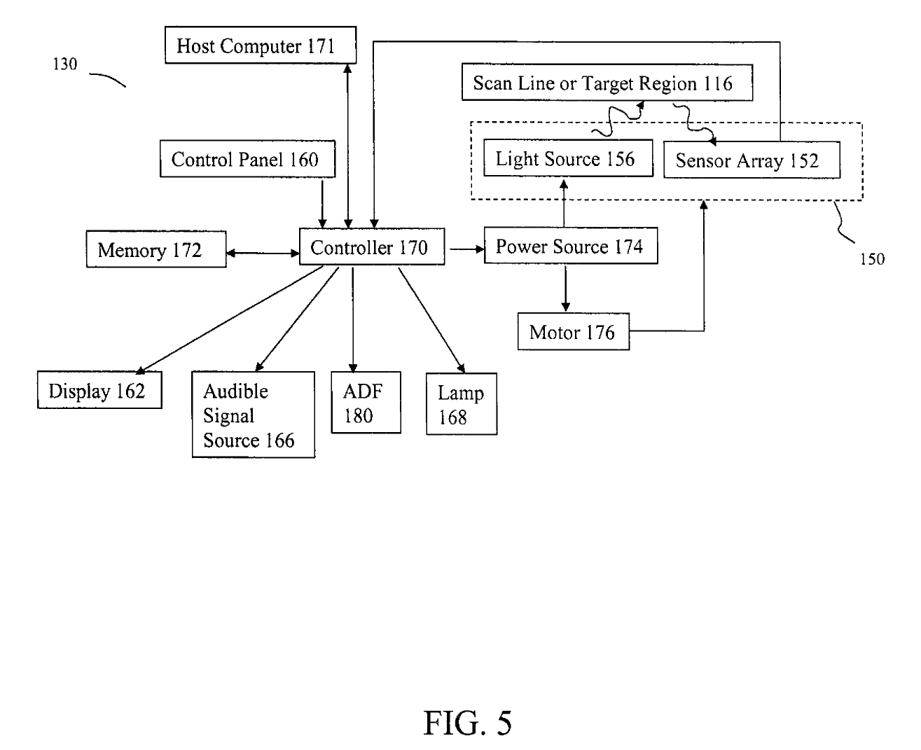

Whether scanning apparatus 130, is a separate unit or is incorporated into a multifunction printer or copier, scanning apparatus will have a controller 170, including hardware and software or firmware. FIG. 5 schematically shows controller 170 and its relationship with other portions of scanning apparatus 130. In normal scanning operation in the active mode of operation, a user can initiate a scanning operation from control panel 160, or alternatively a scanning job can be initiated from host computer 171. In either case a signal is sent to controller 170, which then sends a signal to power source 174 to turn on light source 156 and also to operate motor 176 in order to move sensor array module 150 along scanning direction 135. As sensor array module 150 is moved, light from light source 156 reflects off a document or other object that is placed on scanner glass 140, and impinges on sensor array 152 one scan-line at a time. A scan line signal is sent from sensor array 152 to controller 170 where it may be further processed before sending it to memory 172 (or to host computer 171) in order to compose an entire scanned image signal, scan line by scan line. When the scan is completed, controller 170 sends a signal to power source 174 to send power to motor 176 in order to return sensor array module 150 to its home position.

Controller 170 also can include a timer (not shown) which begins measuring an elapsed time after a scanning job (or other function in a multifunction printer 100) is completed. In some embodiments, if the elapsed time exceeds a threshold time of inactivity, controller 170 initiates a sleep mode for scanning apparatus 130. During the sleep mode, some functions of the scanning apparatus 130 are discontinued. In one embodiment, during the sleep mode, controller 170 sends a pulsing control signal to power source 174 in order to apply pulsed power to light source 156, for example one pulse every half second. When light source 156 is pulsed on as a result, light is directed toward target region 116, for example. If scanner lid 110 is closed, light will be reflected off target region 116 and a predetermined recognizable signal will be produced in sensor array 152 and sent to controller 170. By recognizing this signal, controller 170 will detect that scanner lid 110 is closed. The sending of the predetermined recognizable signal from the sensor array 152 to the controller 170 will also be referred to herein as sending a lid-closed signal to controller 170. Optionally, a logic circuit (not shown) between sensor array 152 and controller 170 will detect the predetermined recognizable signal and send a lid-closed signal to controller 170. However, if when light source 156 is pulsed on, the signal sent from sensor array 152 to controller 170 is not the predetermined recognizable signal, then controller 170 will detect that scanner lid 110 is open. The sending of an unrecognized signal from the sensor array 152 to the controller 170 when light source 156 is turned on will also be referred to herein as sending a lid-open signal to controller 170. Optionally, a logic circuit (not shown) between sensor array 152 and controller 170 will detect an unrecognized signal when light source 156 is turned on, and will send a lid-open signal to controller 170.

When controller 170 detects that the scanner lid 110 is open (by receiving a lid-open signal and/or by ceasing to receive a lid-closed signal, i.e., by analyzing a signal sent from the sensor array 152), controller 170 sends one or more signals to initiate one or more functions and thereby exit the sleep mode. By pulsing light source 156 to detect whether the lid is open, less energy is used than if the light source 156 were always left on. A light source 156 such as an LED, having a fast turn-on time is particularly useful for such pulsing. A pulsing frequency of greater than once per second (for example, twice per second) provides a response time that a user will perceive as relatively fast. By the time the user is able to manually position his document on the scanner glass 140 after opening scanner lid 110, scanner functions are enabled, thereby improving productivity and enhancing the user experience.

In some embodiments, the display 162 is turned off or is in some other mode during the sleep mode, but when controller 170 detects the scanner lid 110 being opened, it sends a signal to display 162 to operate in a mode showing a scan menu or a copy menu, for example. In other embodiments, when controller 170 detects the scanner lid 110 being closed, it sends a signal to display 162 to operate in a different mode. In some embodiments, the signal to display 162 to operate in a different mode is only sent after a predetermined time following the closing of scanner lid 110 or only after the scanner lid 110 has been closed and certain control buttons 164 have been pushed, or certain control operations have been initiated.

In some embodiments, when controller 170 detects the scanner lid 110 being opened or being closed, it sends a signal to audible signal source 166 to produce a sound. Audible signal source 166 is shown in FIG. 5 as being separate from host computer 171, but in some embodiments, audible signal source 166 may be part of host computer 171. The sound produced by audible signal source 166 may be as simple as a chime or a buzzer, but optionally it can be used to customize or personalize the scanning apparatus 130, similar to the way that custom ring-tones are sometimes used for personalizing cell phones. For example, audible signal source 166 could play the sound of a creaky door opening when the scanner lid 110 is being opened, or the sound of a door being slammed shut when scanner lid 110 is being shut. Audible signal source 166 could alternatively be used to provide a language-based message to the user.

Sensor array 152 is preferably calibrated periodically in order to continue to provide high quality scanned images. Calibration can include moving sensor array 152 to a predetermined location (typically where there is a uniform white background) with no document in place, turning on light source 156, and sending the resulting signal to controller 170 for analysis. As a result of the analysis of the signal, controller 170 can increase the light intensity of light source 156 if the overall signal strength is too low, or increase the gain of an amplifier (not shown) or digitally compensate for signal levels from individual photosensor sites that have drifted outside of limits set for signal uniformity. The timing of a calibration can be determined by setting a flag in the controller 170. Setting of such a flag can depend on elapsed time since the previous calibration, for example. In some embodiments, when controller 170 detects the scanner lid 110 being opened, it sets a flag in order to initiate calibration of sensor array 152 prior to the scanning of the next image.

In some embodiments, when controller 170 detects the scanner lid 110 being opened, it sends a signal to turn on lamp 168. Lamp 168 will also be referred to herein as a second light source. Lamp 168 can be an indicator light such as an LED on the control panel 160. Alternatively, lamp 168 can be an illuminator for the scanning process, particularly, if lamp 168 requires a warm-up time. In such an embodiment, light source 156 can be used for detection of the lid being open or closed, but lamp 168 can be used during document scanning.

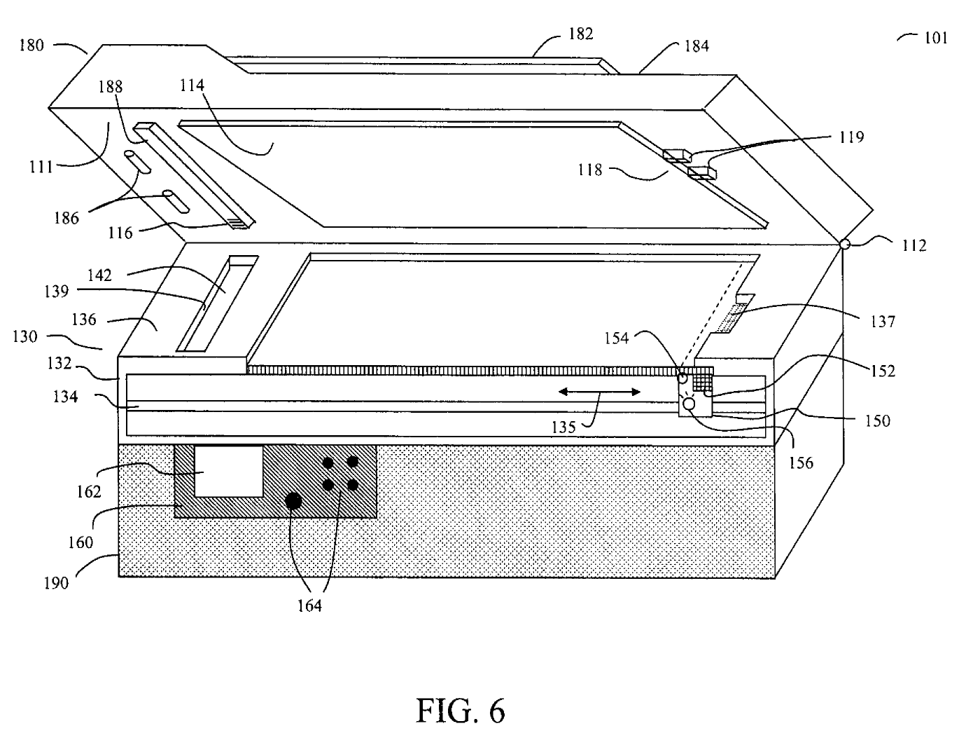

For ease in document handling, many scanners, copiers and multifunction printers include an automatic document feeder. FIG. 6 shows a perspective view of a multifunction printer 101, similar to the multifunction printer 100 shown in FIG. 4, but also including automatic document feeder (ADF) 180, and other associated modifications. ADF 180 includes an input tray 182 where documents for scanning or copying are stacked, output tray 184 for receiving scanned documents, document feed rollers 186 for moving the documents, and reflective backing strip 188 for providing a white background (similar to the function of reflective backing plate 114). The under side 111 of ADF 180 functions similar to scanner lid 110 and includes reflective backing plate 114 with target region 116. Opening or closing ADF 180 is, therefore, equivalent to opening or closing a scanner lid. In the embodiment shown in FIG. 6, a separate scanner glass region 142 is provided for scanning documents being fed by ADF 180. Frame 136 includes an offset region 139 in which scanner glass region 142 is set, so that offset region 139 can accommodate reflective backing strip 188 when ADF 180 is closed over scanner glass 140. In other embodiments, the region for scanning of documents being fed by ADF 180 can be an extension of the scanner glass 140, in which case a separate scanner glass region 142 and a separate reflective backing strip 188 would not be included. For documents to be scanned using ADF 180, sensor array module 150 is moved to a position below scanner glass region 142 and is held in position while ADF 180 feeds documents past it, so that there is still relative motion between the document and the sensor array 152 and an image can be composed one scan line at a time.

Optionally, reflective backing strip 188 can include a target region 116, and a position below scanner glass region 142 can be considered to be a second home position for movable sensor array 152. For example, target region 116 can be located at an end of reflective backing strip 188 (as shown in FIG. 6) so that the end is beyond the document scanning region. In such an example, photoreceptor sites at that end of movable sensor array 152 would not be used for document scanning, but would be extra sites to identify whether target region 116 is adjacent scanner glass region 142 (e.g., whether or not ADF 180 is open). Also in such examples, the target region on reflective backing strip 188 can be configured differently from the target region on reflective backing plate 114, so that when the ADF 180 is closed, the controller 170 will be able to distinguish from the respective recognizable signals whether the sensor array 152 is positioned near the first home position next to scanner glass 140 or near the second home position next to scanner glass region 142. In some embodiments, the reflective backing strip 188 is entirely white, and the “target region” in that case can be the entire reflective backing strip 188, with the recognizable signal corresponding to a uniformly white scan line. By providing target regions for both the first home position for manual scanning and the second home position for scanning of documents being automatically fed, the controller 170 will know whether the automatic document feeder is open or closed, regardless of which home position the sensor array 152 is at. In general, a home position is wherever the scanning bar is in optical communication with the target region.

For proper operation of ADF 180, documents are fed between reflective backing strip 188 and the adjacent scanner glass region 142. However, if ADF 180 is open, as it is in the view shown in FIG. 6, reflective backing strip 188 is not adjacent to scanner glass region 142. If the ADF 180 is open it is undesirable to feed documents through the document feeder or misfeeds can result. In some embodiments, when controller 170 detects the ADF 180 being opened, it sends a signal to disable operation of the automatic document feeder.

In embodiments where the sensor array 152 can reside at either home position when the lid is closed (depending, for example, on whether manual scanning or automatic document feeding was done most recently), it can be desirable to move the sensor array 152 to the home position for manual scanning near scanner glass 140 when the ADF 180 is opened in order to prepare for manual scanning. In such embodiments, when controller 170 detects the ADF 180 being opened, if the controller 170 had just previously received a signal indicating that the sensor array 152 was located near scanner glass region 142 for automatic document feeding it sends a signal to move the sensor array 152 to the home position for manual scanning.

The invention has been described in detail with particular reference to certain preferred embodiments thereof but it will be understood that variations and modifications can be effected within the spirit and scope of the invention.

### PARTS LIST

100 Multifunction printer
101 Multifunction printer with automatic document feeder
110 Scanner lid
111 Under side of automatic document feeder
112 Hinge
114 Reflective backing plate
115 Target region with black blocks and white spaces
116 Target region
117 Target region with gray region
118 Target region using projections from 114
119 Projections from 114
130 Scanning apparatus
132 Scanning apparatus body
134 Scanning guide
135 Scanning direction
136 Frame
138 Offset for reflective backing plate 114
139 Offset for reflective backing strip 188
140 Scanner glass (transparent plate)
142 Scanner glass region for automatic document feeder
150 Sensor array module
152 Sensor array
154 Roller of sensor array module
156 Light source
158 Light guide
160 Control panel
162 Display
164 Control buttons
166 Audible signal source
168 Lamp
170 Controller
171 Host computer
172 Memory
174 Power source
176 Motor
180 Automatic document feeder
182 Input tray
184 Output tray
186 Document feed rollers
188 Reflective backing strip for automatic document feeder
190 Printing apparatus
210 Sensor array signal corresponding to FIG. 2A with lid closed
211 Sensor array signal corresponding to FIG. 4A with lid closed
215 Sensor array signal pattern portion corresponding to target region 115
217 Sensor array signal pattern portion corresponding to target region 117
219 Sensor array signal peaks corresponding to projections 119

What is claimed is:

1. A scanning apparatus for scanning an image, comprising:
a transparent plate;
a target region having a predetermined optical reflectance;
a movable sensor array, including a home position that is in optical communication with the target region when a lid of the scanning apparatus is closed;
a light source for illuminating the target region; and
a controller for analyzing a signal sent from the movable sensor array and subsequently initiating at least one function for the scanning apparatus.

2. The scanning apparatus of claim 1, the movable sensor array comprising a first sensor detecting a first portion of the target region, and a second sensor detecting a second portion of the target region, said first sensor and second sensor produce a predetermined signal when the lid is closed.

3. The scanning apparatus of claim 2, the transparent plate being positioned between the movable sensor array and the target region.

4. The scanning apparatus of claim 1, wherein the target region includes a white region.

5. The scanning apparatus of claim 4, wherein the target region includes a projection from an edge of a reflective plate.

6. The scanning apparatus of claim 4, wherein the target region includes a plurality of projections.

7. The scanning apparatus of claim 4, wherein the target region includes a first region of optical reflectance and a second region of optical reflectance different from the first region of optical reflectance.

8. The scanning apparatus of claim 1, further comprising a display.

9. The scanning apparatus of claim 1, further comprising an automatic document feeder.

10. The scanning apparatus of claim 1, wherein the light source includes an LED.

11. A method for detecting whether a lid of a scanning apparatus is open, the method comprising the steps of:
positioning a movable sensor array proximate to a target region;
illuminating the target region with a light source;
receiving in the movable sensor array a predetermined optical signal corresponding to the target region if the lid is closed; and
sending a lid-open signal to a controller of the scanning apparatus if the predetermined optical signal corresponding to the target region is not received in the movable sensor array when the light source is on; or
sending a lid-closed signal to the controller of the scanning apparatus if the predetermined optical signal corresponding to the target region is received in the movable sensor array when the light source is on.

12. The method of claim 11 further comprising the step of sending a signal from the controller of the scanning apparatus to operate a display when either the lid-closed signal or the lid-open signal is received by the controller.

13. The method of claim 11, further comprising the step of:
sending an audible signal from the controller of the scanning apparatus when either the lid-closed signal or the lid-open signal is received by the controller.

14. The method of claim 11, further comprising the step of:
setting a flag in the controller of the scanning apparatus when the lid-open signal is received by the controller in order to initiate calibration of the sensor array prior to the scanning of the next image.

15. The method of claim 11, further comprising the step of:
sending a signal from the controller of the scanning apparatus to disable operation of an automatic document feeder when the lid-open signal is received by the controller.

16. The method of claim 11, further comprising the step of:
sending a signal from the controller of the scanning apparatus to move the sensor array to a home position for manual document scanning when the lid-open signal is received by the controller, if a previous signal to the controller indicated the presence of the sensor array in a position for automatic document feeding.

17. The method of claim 11, farther comprising the step of:
sending a signal from the controller of the scanning apparatus to turn on a lamp when the lid-open signal is received by the controller.

18. The method of claim 11, wherein the light source is pulsed at a frequency that is higher than once per second.
